(19) United States
(12) Patent Application Publication
(10) Pub. No.: US 2024/0010802 A1
(43) Pub. Date: Jan. 11, 2024

(54) POROUS POLYIMIDE FILM AND POLYIMIDE PRECURSOR SOLUTION

(71) Applicant: FUJIFILM Business Innovation Corp., Tokyo (JP)

(72) Inventors: Hajime SUGAHARA, Kanagawa (JP); Hidekazu Hirose, Kanagawa (JP); Kosaku Yoshimura, Kanagawa (JP); Shigeru Seitoku, Kanagawa (JP); Kosuke Nakada, Kanagawa (JP); Satoshi Yoshida, Kanagawa (JP)

(73) Assignee: FUJIFILM Business Innovation Corp., Tokyo (JP)

(21) Appl. No.: 18/156,405

(22) Filed: Jan. 19, 2023

(30) Foreign Application Priority Data
Jul. 5, 2022 (JP) 2022-108605

(51) Int. Cl. C08J 5/18; C08L 79/08; C08J 9/00; C08J 9/28

(52) U.S. Cl. CPC C08J 5/18; C08L 79/08; C08J 9/0061; C08J 9/286; C08L 2203/16; C08J 2379/08; C08J 2425/06; C08J 2205/042; C08J 2205/044

(57) ABSTRACT

A porous polyimide film has a ratio of a cross-sectional average micro pore diameter (μm) to a first surface micro pore diameter (μm) on one surface (the cross-sectional average micro pore diameter/the first surface micro pore diameter) of equal to or more than 5 and equal to or less than 10.

### CROSS-REFERENCE TO RELATED APPLICATIONS

This application is based on and claims priority under 35 USC 119 from Japanese Patent Application No. 2022-108605 filed Jul. 5, 2022.

### BACKGROUND

### (i) Technical Field

The present invention relates to a porous polyimide film and a polyimide precursor solution.

### (ii) Related Art

JP2020-147685A discloses “a porous polyimide film having a surface layer, a surface layer, and a macrovoid layer sandwiched between the surface layer and the surface layer, in which the macrovoid layer includes a partition wall bonded to the surface layers and a plurality of macrovoids surrounded by the partition wall and the surface layers and having a number average pore diameter of 10 μm to 500 μm in a film plane direction, a thickness of the partition wall of the macrovoid layer is 0.1 μm to 50 μm, each thickness of the surface layer is 0.1 μm to 50 μm, each of the surface layers has a plurality of micro pores having an area average opening diameter of 20 μm or more, the surface layers and the micro pores communicate with the macrovoid, an area average opening diameter A of the surface layer and an area average opening diameter B of the surface layer satisfy the following relationship: 0.80≤A/B≤1.25, a surface opening ratio of the surface layer is equal to or more than 5%, and a surface opening ratio of the surface layer is equal to or more than 10%.”

JP2021-095558A discloses “a polyimide precursor solution including a polyimide precursor and an aqueous solvent including an imidazole compound, a tertiary amine compound other than the imidazole compound, and water, in which a ratio of the number of moles of the imidazole compound to the number of moles of a tetracarboxylic acid dianhydride component of the polyimide precursor is equal to or more than 0.2 times in terms of mole and less than 1.6 times in terms of mole, a ratio of the number of moles of the tertiary amine compound to the number of moles of the imidazole compound is equal to or more than 0.3 times in terms of mole and equal to or less than 6.0 times in terms of mole, and the water content is equal to or more than 50% by mass with respect to the aqueous solvent”.

JP2019-217501A discloses “a composite medium including a porous intermediate layer having first and second surfaces facing each other, a first fiber-containing filter layer disposed on the first surface of the intermediate layer, and a second fiber-containing filter layer disposed on the second surface of the intermediate layer, fibers of the first and second fiber-containing filter layers have different fiber diameters, each of the fiber-containing filter layers has a different micro pore diameter grade, and the intermediate layer has a coarser micro pore diameter than any of the first or second fiber-containing filter layer”.

### SUMMARY

In the related art, there is a tendency that in an attempt to obtain a porous polyimide film having excellent air permeability, filtration properties deteriorate. Therefore, aspects of non-limiting embodiments of the present disclosure relate to a porous polyimide film that excellent in both filtration properties and air permeability compared to a case where a ratio of a cross-sectional average micro pore diameter (μm) to a first surface micro pore diameter (μm) on one surface (cross-sectional average micro pore diameter/first surface micro pore diameter) is less than 5 or more than 10.

In addition, aspects of non-limiting embodiments of the present disclosure relate to a polyimide precursor solution that includes an aqueous solvent containing water, a polyimide precursor which is a polymer of a tetracarboxylic acid dianhydride and a diamine compound, resin particles, an imidazole compound, and a tertiary amine compound other than the imidazole compound, and that may obtain a porous polyimide film excellent in both filtration properties and air permeability compared to a case where a ratio of the number of moles of the imidazole compound to the number of moles of the tetracarboxylic acid dianhydride components of the polyimide precursor is less than 2 times in terms of mole, or a ratio of the number of moles of the tertiary amine compound to the number of moles of the imidazole compound is less than 4 times in terms of mole, and a method of manufacturing a porous polyimide film.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

Specific means for solving the above-described problems include the following aspects.

According to an aspect of the present disclosure, there is provided a porous polyimide film, in which a ratio of a cross-sectional average micro pore diameter (μm) to a first surface micro pore diameter (μm) on one surface (the cross-sectional average micro pore diameter/the first surface micro pore diameter) is equal to or more than 5 and equal to or less than 10.

### BRIEF DESCRIPTION OF THE DRAWINGS

Exemplary embodiment(s) of the present invention will be described in detail based on the following FIGURES, wherein:

FIG. 1 is a schematic view showing an example of a method of obtaining a cross-sectional micro pore diameter in a porous polyimide film according to the present exemplary embodiment.

### DETAILED DESCRIPTION

Hereinafter, an exemplary embodiment of the present invention will be described. Descriptions and examples herein exemplify exemplary embodiments and do not limit the scope of the exemplary embodiment.

In the numerical value range described stepwise in the present specification, an upper limit value or a lower limit value described in one numerical value range may be substituted with an upper limit value or a lower limit value of another numerical value range described stepwise. In addition, in the numerical value range described in the present disclosure, the upper limit value or the lower limit value of the numerical value range may be substituted with the value shown in the examples.

Each component in the present specification may contain a plurality of corresponding substances.

In a case of referring to an amount of each component in a composition in the present specification, in a case where a plurality of substances corresponding to each component is present in the composition, unless otherwise specified, the amount means a sum of the plurality of substances present in the composition.

In the present exemplary embodiment, “film” is a concept that includes not only what is generally called “film” but also what is generally called “film” and “sheet”.

In the porous polyimide film according to the present exemplary embodiment, the ratio of the cross-sectional average micro pore diameter (μm) to the first surface micro pore diameter (μm) on one surface (cross-sectional average micro pore diameter/first surface micro pore diameter) is equal to or more than 5 and equal to or less than 10.

In the related art, there have been known techniques for reducing the surface micro pore diameter in order to improve filtration properties of a porous polyimide film. However, in a case where the surface micro pore diameter of the porous polyimide film is reduced, there is a tendency that the average micro pore diameter of a cross section in a thickness direction of the porous polyimide film (hereinafter, also referred to as “cross-sectional average micro pore diameter”) becomes smaller. In a case where the cross-sectional average micro pore diameter becomes small, air permeability of the porous polyimide film deteriorates. As described above, in the porous polyimide film in the related art, it is difficult to achieve both filtration properties and air permeability.

On the other hand, in the porous polyimide film according to the present exemplary embodiment, the ratio of the cross-sectional average micro pore diameter (μm) to the first surface micro pore diameter (μm) on one surface (cross-sectional average micro pore diameter/first surface micro pore diameter) is equal to or more than 5 and equal to or less than 10. That is, there is a tendency that the cross-sectional average micro pore diameter is larger than the first surface micro pore diameter. Therefore, the air permeability is excellent while maintaining the filtration properties.

Characteristics of Porous Polyimide Film

In the porous polyimide film, the ratio of the cross-sectional average micro pore diameter (μm) to the first surface micro pore diameter (μm) on one surface (cross-sectional average micro pore diameter/first surface micro pore diameter) is equal to or more than 5 and equal to or less than 10, for example, preferably equal to or more than 5 and equal to or less than 9.5, and more preferably equal to or more than 5 and equal to or less than 9.

In a case where the ratio (cross-sectional average micro pore diameter/first surface micro pore diameter) is equal to or more than 5, since the cross-sectional average micro pore diameter is appropriately larger than the first surface micro pore diameter, both filtration properties and air permeability are excellent.

In a case where the ratio (cross-sectional average micro pore diameter/first surface micro pore diameter) is equal to or less than 10, independent pores are formed in a case where adhesion between particles progresses and the micro pore diameter in the film becomes large, and a connection hole penetrating between the one surface of the porous polyimide film and a surface facing of the one surface is suppressed from being hardly formed. As a result, since the cross-sectional average micro pore diameter is suppressed from becoming excessively large, filtration properties become more excellent.

The one surface refers to one surface of a pair of surfaces facing each other in a film thickness direction in the porous polyimide.

The first surface micro pore diameter is, for example, preferably equal to or more than 50 nm and equal to or less than 2 μm, for example, more preferably equal to or more than 50 nm and equal to or less than 1.8 μm, and further more preferably equal to or more than 50 nm and equal to or less than 1.6 μm.

In a case where the first surface micro pore diameter is equal to or more than 50 nm, clogging due to an excessively small surface micro pore diameter is likely to be suppressed, and the air permeability is more excellent. In addition, adsorption properties of a removal target are improved, and filtration properties are more excellent. In addition, rapid filtration properties may be easily obtained.

In a case where the first surface micro pore diameter is 2 μm or less, the effect of preferentially permeating molecules having a certain size or smaller (hereinafter, also referred to as “molecular sieving effect”) is improved, and filtration properties are more excellent.

The cross-sectional average micro pore diameter is, for example, preferably equal to or more than 250 nm and equal to or less than 20 μm, for example, more preferably equal to or more than 250 nm and equal to or less than 18 μm, further more preferably equal to or more than 250 nm and equal to or less than 16 μm, and further more preferably equal to or more than 400 nm and equal to or less than 10 μm.

In a case where the cross-sectional average micro pore diameter is equal to or more than 250 nm, the molecular sieving effect is improved, and thus air permeability is more excellent.

In a case where the cross-sectional average micro pore diameter is equal to or less than 20 μm, deterioration of adsorption properties of the removal target is suppressed, and filtration properties are more excellent. In addition, deterioration in the strength of the film is suppressed.

In the porous polyimide film, a ratio of the cross-sectional average micro pore diameter (μm) to the second surface micro pore diameter (μm) of a surface facing the one surface (so-called back surface) (cross-sectional average micro pore diameter/second surface micro pore diameter) is, for example, preferably equal to or more than 2 and equal to or less than 5, more preferably equal to or more than 2 and equal to or less than 4.5, and further more preferably equal to or more than 2 and equal to or less than 4.

In a case where the ratio (cross-sectional average micro pore diameter/second surface micro pore diameter) is equal to or more than 2, the molecular sieving effect is more likely to be improved, and air permeability is more excellent.

In a case where the ratio (cross-sectional average micro pore diameter/second surface micro pore diameter) is equal to or less than 5, deterioration in adsorption properties of the removal target is suppressed, and filtration properties are more excellent. In addition, deterioration in the strength of the film is suppressed.

The second surface micro pore diameter is, for example, preferably equal to or more than 100 nm and equal to or less than 15 μm, more preferably equal to or more than 100 nm and equal to or less than 13 μm, and further more preferably equal to or more than 100 nm and equal to or less than 11 μm.

In a case where the second surface micro pore diameter is equal to or more than 100 nm, clogging due to an excessively small surface micro pore diameter is likely to be suppressed, and air permeability is more excellent. In addition, adsorption properties of a removal target are improved, and filtration properties are more excellent. In addition, rapid filtration properties can be easily obtained.

In a case where the second surface micro pore diameter is equal to or less than 15 μm, the molecular sieving effect is improved, and filtration properties are more excellent.

Measurement of the first surface micro pore diameter and the second surface micro pore diameter is performed as follows.

The surface of the porous polyimide film is observed with a scanning electron microscope (S-4100, manufactured by Hitachi, Ltd.) to capture an image. At this time, the scanning electron microscope is adjusted to a magnification at which a plurality of micro pores of the porous polyimide film can be observed, thereby capturing an image. For micro pores at any 10 points that can be confirmed from the obtained image, a circle-equivalent diameter of each micro pore is obtained, and an arithmetic average value thereof is defined as the surface micro pore diameter.

Measurement of the cross-sectional average micro pore diameter is performed as follows.

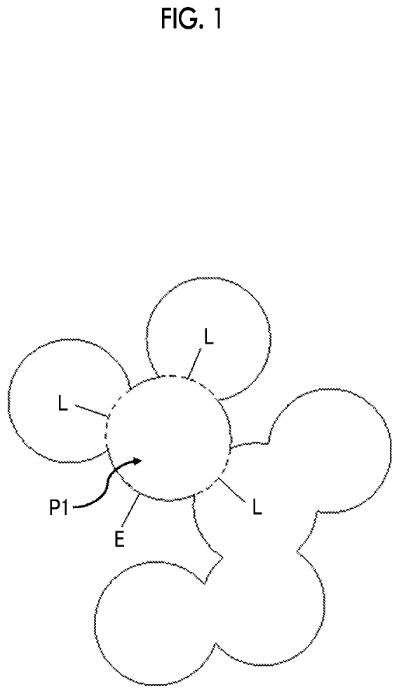

The porous polyimide film is cut in the thickness direction, and a cut surface thereof is observed with a scanning electron microscope (S-4100, manufactured by Hitachi, Ltd.) to capture an image. At this time, the scanning electron microscope is adjusted to a magnification at which a plurality of micro pores of the porous polyimide film can be observed, thereby capturing an image. For micro pores at any 10 points that can be confirmed from the obtained image, a virtual line L is drawn at a communication point along a region that can be recognized granularly from an edge E of the micro pores in the micro pores to be observed, and a region surrounded by the edge E of the micro pore and the virtual line is recognized as one micro pore P1 (refer to FIG. 1). Then, the longest circle-equivalent diameter of the micro pore P1 is obtained, and an arithmetic average value of the circle-equivalent diameter of each micro pore is defined as a cross-sectional average micro pore diameter.

A technique of adjusting the cross-sectional average micro pore diameter, the first surface micro pore diameter, and the second surface micro pore diameter to the above-mentioned preferable ranges, for example, is not particularly limited, and examples thereof include a technique of using a polyimide precursor solution used for manufacturing a porous polyimide film as a polyimide precursor solution according to the present exemplary embodiment to be described later and the like.

In the porous polyimide film, for example, air permeability is, for example, preferably equal to or less than 20 seconds, more preferably equal to or more than 1 second and equal to or less than 18 seconds, and further more preferably equal to or more than 1 second and equal to or less than 16 seconds.

In a case where air permeability is equal to or less than 20 seconds, the effect of preferentially permeating molecules having a certain size or smaller (hereinafter, also referred to as “molecular sieving effect”) is improved, and filtration properties are more excellent.

In a case where the air permeability is equal to or more than 1 second, the molecular sieving effect is improved, and thus the air permeability is more excellent.

Measurement of air permeability is performed as follows.

A porous polyimide film is cut into 1 cm² squares (the thickness is the thickness of the porous polyimide film to be measured), and a test specimen is obtained. The test specimen is set by being interposed between a funnel of a filter holder for decompression filtration (KGS-04 manufactured by TOYO ROSHI KAISHA, Ltd.) and a base portion. Then, the filter holder interposing the test specimen is immersed in water upside down, filled with water to a predetermined position in the funnel, and an air pressure of 0.5 pressure (0.05 MPas) is applied from a side where the funnel of the base portion and the base portion are not in contact with each other. Then, the time (seconds) through which 50 ml of air passes is measured and used as air permeability.

In the porous polyimide film, for example, a porosity is preferably equal to or more than 40%, more preferably equal to or more than 40% and equal to or less than 65%, and further more preferably equal to or more than 40% and equal to or less than 60%.

In a case where the porosity is equal to or more than 40%, the molecular sieving effect is improved, and thus air permeability is more excellent.

In a case where the porosity is equal to or less than 65%, deterioration in adsorption properties of the removal target is suppressed, and filtration properties are more excellent. In addition, deterioration in the strength of the film is suppressed.

The porosity is obtained from apparent density and true density of the porous polyimide film. The apparent density d is a value obtained by dividing a mass (g) of the porous polyimide film by a volume (cm³) of the porous polyimide film including the pores. The apparent density d may be obtained by dividing the mass (g/m²) per unit area of the porous polyimide film by a thickness (μm) of the porous polyimide film. True density p is a value obtained by dividing the mass (g) of the porous polyimide film by a volume of the porous polyimide film excluding pores (that is, the volume (cm³) of only a skeleton portion made of resin).

The porosity is calculated by the following formula (II).

Porosity (% by volume)={1−(d/ρ)}×100=[1−{(w/t)/ρ)}]×100 Formula (II)
d: Apparent density of porous polyimide film (g/cm³)
ρ: True density of porous polyimide film (g/cm³)
w: Mass per unit area of porous polyimide film (g/m²)
t: Thickness of porous polyimide film (μm)

The porous polyimide film may be a laminated body or a single layer, and for example, a single layer is preferable. In a case where the porous polyimide film is a single layer, resin particles that have not yet become pores after being fired are more likely to adhere to each other during film formation, as compared with a laminated body. Therefore, in order to form connection holes that communicate between one surface of the porous polyimide film and a surface facing the one surface, for example, filtration properties and air permeability can be easily adjusted to more suitable ranges.

An average film thickness of the porous polyimide film is not particularly limited and is selected depending on the intended use.

The average film thickness of the porous polyimide film may be, for example, equal to or more than 10 μm and equal to or less than 1,000 μm, may be equal to or more than 20 μm and equal to or less than 500 μm, or may be equal to or more than 30 μm and equal to or less than 400 μm.

For example, in a case where a porous polyimide film is used as a filtration film, the average film thickness of the porous polyimide film is, for example, preferably equal to or more than 1 μm and equal to or less than 500 μm, more preferably equal to or more than 1 μm and equal to or less than 250 μm, and more preferably equal to or more than 1 μm and equal to or less than 100 μm, from a viewpoint of making the porous polyimide film more excellent in filtration properties.

The average film thickness of the porous polyimide film is calculated by measuring the film thickness of the porous polyimide film at five points using a vortex current type film thickness meter CTR-1500E manufactured by Sanko Denshi Co., Ltd. and obtaining an arithmetic average thereof.

Use of Porous Polyimide Film

Use of the porous polyimide film is not particularly limited, and examples thereof include a filter material such as a separation film of gas or liquid and a filtration film; an insulating film which is a coating film in an insulated wire; a battery separator such as a lithium battery; a separator used for an electrolytic capacitor; an electrolyte film of a fuel cell and the like; a battery electrode material; a low dielectric constant material; and the like. Among the above, the porous polyimide film according to the present exemplary embodiment is useful as a filter material such as a separation film of gas or liquid and a filtration film.

Polyimide Precursor Solution

The polyimide precursor solution according to the present exemplary embodiment includes an aqueous solvent containing water, a polyimide precursor which is a polymer of a tetracarboxylic acid dianhydride and a diamine compound, resin particles, an imidazole compound, and a tertiary amine compound other than the imidazole compound, a ratio of the number of moles of the imidazole compound to the number of moles of the tetracarboxylic acid dianhydride component of the polyimide precursor is equal to or more than 2 times in terms of mole and equal to or less than 10 times in terms of mole, and a ratio of the number of moles of the tertiary amine compound to the number of moles of the tetracarboxylic acid dianhydride component of the polyimide precursor is equal to or more than 2 times in terms of mole and equal to or less than 18 times in terms of mole.

The porous polyimide film has attracted attention as a filter material such as a filter. The porous polyimide film can be, for example, produced by applying a polyimide precursor solution onto a substrate or the like, and then heat-drying the porous polyimide film to make a portion of a region where resin particles exist into pores by thermal decomposition of the resin particles through a step of making the film porous.

As one of means for controlling filtration properties of the porous polyimide film, there is known a technique of reducing the surface micro pore diameter of the porous polyimide film. However, in an attempt to reduce the surface micro pore diameter of the porous polyimide film by using a polyimide precursor solution in the related art, there is a tendency that the size of the micro pores inside the film that is not exposed to the surface also decreases, and air permeability deteriorates.

On the other hand, since the polyimide precursor solution according to the present exemplary embodiment has the above constitution, in a case where a porous polyimide film is formed using thereof, the surface micro pore diameter is reduced while the size of the micro pores inside the film is small and can be easily controlled, and a porous polyimide film excellent in both filtration properties and air permeability can be obtained. This mechanism of action is not always clear, but it is presumed as follows.

In the polyimide precursor solution according to the present exemplary embodiment, the ratio of the number of moles of the imidazole compound to the number of moles of the tetracarboxylic acid dianhydride component of the polyimide precursor is equal to or more than 2 times in terms of mole. The imidazole compound has a catalytic action during imidizing (dehydrating and ring-closing) the polyimide precursor to form polyimide, and has a role of increasing affinity of the polyimide precursor with the resin particles. Therefore, by including a large proportion of the imidazole compound with respect to the number of moles of the tetracarboxylic acid dianhydride component, imidization can easily proceed while the resin particles and the polyimide precursor are fused inside the coating film during film formation. As a result, the micro pores inside the porous polyimide film become larger than the surface micro pore diameter of the porous polyimide film, and air permeability of the porous polyimide film is excellent.

In addition, in a case where the ratio of the number of moles of the imidazole compound to the number of moles of the tetracarboxylic acid dianhydride component of the polyimide precursor is 10 times in terms of mole or less, the resin particles and the polyimide precursor inside the coating film are excessively fused and the micro pores inside the film are suppressed from becoming too large during film formation, and thus filtration properties of the porous polyimide film are excellent.

In addition, the polyimide precursor solution according to the present exemplary embodiment has a specification of including a relatively large amount of the tertiary amine compound, in which the ratio of the number of moles of the tertiary amine compound to the number of moles of the tetracarboxylic acid dianhydride component of the polyimide precursor is equal to or more than 2 times in terms of mole. The tertiary amine compound, together with an aqueous solvent containing water, has a property of easily volatilizing from the surface of the coating film and having a lower affinity with resin particles than the imidazole compound. Therefore, during film formation, a relatively large amount of the tertiary amine compound can easily volatilize from the surface of the coating film. In addition, as the proportion of the tertiary amine compound increases on the surface of the coating film, the resin particles can be relatively localized inside the coating film. As a result, the surface micro pore diameter becomes small on the surface of the coating film in which the amount of the resin particles present is relatively small, and the micro pore can become easily large inside the coating film in which the amount of the resin particles present is relatively large. As a result, it is considered that a porous polyimide film which is excellent in filtration properties because the surface micro pore diameter is small and is excellent in air permeability because the micro pore diameter inside the film is large may be obtained.

In addition, in a case where the ratio of the number of moles of the tertiary amine compound to the number of moles of the tetracarboxylic acid dianhydride component of the polyimide precursor is equal to or less than 18 times in terms of mole, it is suppressed that the amount of the resin particles present on the surface of the coating film becomes excessively small and the surface micro pore diameter becomes excessively small, and thus air permeability is excellent. In addition, it is suppressed that the amount of the resin particles present inside the coating film becomes excessively large and the micro pore diameter inside the film becomes excessively large, and thus filtration properties are excellent.

According to the polyimide precursor solution according to the present exemplary embodiment, the cross-sectional average micro pore diameter (μm) of the porous polyimide film, the first surface micro pore diameter (μm) of one surface, and the second surface micro pore diameter (μm) of the surface facing the one surface, and a ratio thereof can be set in the above-mentioned official range.

The number of moles of the tetracarboxylic acid dianhydride component of the polyimide precursor is the number of moles of the tetracarboxylic acid dianhydride in a case of manufacturing the polyimide precursor.

In addition, the number of moles of the imidazole compound is the number of moles of the imidazole compound contained in the polyimide precursor solution.

In addition, the number of moles of the tertiary amine compound is the number of moles of the tertiary amine compound contained in the polyimide precursor solution.

Characteristics of Polyimide Precursor Solution

In the polyimide precursor solution, a ratio of the number of moles of the imidazole compound to the number of moles of the tetracarboxylic acid dianhydride component of the polyimide precursor is, for example, equal to or more than 2 times in terms of mole and equal to or less than 10 times in terms of mole, preferably equal to or more than 2 times in terms of mole and equal to or less than 6 times in terms of mole, and more preferably equal to or more than 2 times in terms of mole and equal to or less than 5 times in terms of mole.

In a case where the ratio of the number of moles of the imidazole compound to the number of moles of the tetracarboxylic acid dianhydride component of the polyimide precursor is equal to or more than 2 times in terms of mole, imidization easily proceeds while resin particles and the polyimide precursor are fused inside the coating film, the micro pore inside the porous polyimide film is larger than the surface micro pore diameter of the porous polyimide film, during film formation, and air permeability of the porous polyimide film is more excellent.

In addition, in a case where the ratio of the number of moles of the imidazole compound to the number of moles of the tetracarboxylic acid dianhydride component of the polyimide precursor is equal to or less than 10 times in terms of mole, it is suppressed that resin particles and the polyimide precursor are excessively fused inside the coating film, during film formation, and the micro pores inside the film become too large, and thus filtration properties of the porous polyimide film are more excellent.

In the polyimide precursor solution, the ratio of the number of moles B of the tertiary amine compound to the number of moles of the tetracarboxylic acid dianhydride component of the polyimide precursor is equal to or more than 4 times in terms of mole and equal to or less than 18 times in terms of mole, for example, preferably equal to or more than 4 times in terms of mole and equal to or less than 15 times in terms of mole, and more preferably equal to or more than 4 times in terms of mole and equal to or less than 12 times in terms of mole.

In a case where the ratio of the number of moles of the tertiary amine compound to the number of moles of the tetracarboxylic acid dianhydride component of the polyimide precursor is equal to or more than 2 times in terms of mole, during film formation, the surface micro pore diameter becomes small on the surface of the coating film in which the amount of the resin particles present is relatively small, and the micro pores can be easily large inside the coating film in which the amount of the resin particles present is relatively large. As a result, both filtration properties and air permeability are more excellent.

In a case where the ratio of the number of moles of the tertiary amine compound to the number of moles of the tetracarboxylic acid dianhydride component of the polyimide precursor is equal to or less than 18 times in terms of mole, it is suppressed that the amount of the resin particles present on the surface of the coating film becomes excessively small and the surface micro pore diameter becomes excessively small, during film formation, and thus air permeability is more excellent. In addition, it is suppressed that the amount of resin particles present inside the coating film is excessively large and the micro pore diameter inside the film is excessively large, and thus filtration properties are more excellent.

In the polyimide precursor solution, a ratio (B/A) of the number of moles B of the tertiary amine compound to the number of moles A of the imidazole compound is equal to or more than 0.4 times in terms of mole and equal to or less than 9 times in terms of mole, for example, preferably equal to or more than 0.6 times in terms of mole and equal to or less than 8.5 times in terms of mole, and more preferably equal to or more than 0.7 times in terms of mole and equal to or less than 8 times in terms of mole.

In a case where the ratio (B/A) is equal to or more than 0.4, during film formation, the surface micro pore diameter becomes small on the surface of the coating film in which the amount of the resin particles present is relatively small and the micro pore can become large inside the coating film in which the amount of the resin particles present is relatively large. As a result, both filtration properties and air permeability are more excellent.

In a case where the ratio (B/A) is equal to or less than 9 times in terms of mole, it is suppressed that the amount of the resin particles present on the surface of the coating film is excessively small and the surface micro pore diameter is excessively small, during film formation, and thus air permeability is more excellent. In addition, it is suppressed that the amount of resin particles present inside the coating film is excessively large and the micro pore diameter inside the film is excessively large, and thus filtration properties are more excellent.

In the polyimide precursor solution, a difference (I_{BP}−A_{BP}) between a boiling point I_{BP} of the imidazole compound and a boiling point A_{BP} of a tertiary amine compound other than the imidazole compound is, for example, preferably equal to or higher than 30° C. and equal to or lower than 200° C., more preferably equal to or higher than 30° C. and equal to or lower than 180° C., and further more preferably equal to or higher than 30° C. and equal to or lower than 150° C.

In a case where the difference (I_{BP}−A_{BP}) is equal to or higher than 30° C., the imidazole compound having a higher catalytic activity for imidization than the tertiary amine compound volatilizes first during film formation, imidization of the polyimide precursor on the surface of the coating film is unlikely to excessively proceed, and the surface micro pore diameter is suppressed from becoming appropriately small, and thus filtration properties of the porous polyimide film are more excellent.

In a case where the difference (I_{BP}−A_{BP}) is equal to or lower than 200° C., it may be easily suppressed that an imidazole compound having a high catalytic activity for imidization volatilizes before imidization sufficiently proceeds both on the surface and inside of the coating film, and both filtration properties and air permeability of the porous polyimide film are more excellent.

In the polyimide precursor solution, the difference (I_{BP}−P_{MP}) between the boiling point I_{BP} of the imidazole compound and a melting point P_{MP} of the resin particles is, for example, preferably equal to or higher than 30° C. and equal to or lower than 160° C., more preferably equal to or higher than 30° C. and equal to or lower than 140° C., and further more preferably equal to or higher than 30° C. and equal to or lower than 120° C.

In a case where the difference (I_{BP}−P_{MP}) is equal to or higher than 30° C., the imidazole compound volatilizes first during film formation, imidization of the polyimide precursor on the surface of the coating film is unlikely to excessively proceed, and the surface micro pore diameter is suppressed from becoming appropriately small, and thus filtration properties of the porous polyimide film are more excellent.

In a case where the difference (I_{BP}−P_{MP}) is equal to or higher than 160° C., during film formation, adhesion between the imidazole compound and the resin particles increases, and the micro pore diameter inside the film of the porous polyimide film may easily become large, and air permeability is more excellent.

Aqueous Solvent

An aqueous solvent is an aqueous solvent containing water.

Examples of water include distilled water, ion-exchanged water, ultrafiltered water, pure water, and the like.

A content of water is, for example, preferably 50% by mass or more, more preferably equal to or more than 70% by mass and equal to or less than 100% by mass, and further more preferably equal to or more than 80% by mass and equal to or less than 100% by mass with respect to the entire aqueous solvent. By setting the content of water within the numerical value range, a boiling point of the aqueous solvent is further lowered. Therefore, the aqueous solvent is further easily boiled in gaps between the polyimide precursors. With this, a larger number of pores formed by the volatilization of the aqueous solvent are formed, and air permeability is more excellent.

The aqueous solvent may contain a solvent other than water.

As the solvent other than water, for example, the solvent is preferably water-soluble. Here, water-soluble means that a target substance is dissolved in water by equal to or more than 1% by mass at 25° C.

Examples of the solvent other than water include a water-soluble organic solvent and an aprotic polar solvent. The solvent other than water is, for example, preferably an aprotic polar solvent.

Examples of the water-soluble organic solvent include a water-soluble ether-based solvent, a water-soluble ketone-based solvent, a water-soluble alcohol-based solvent, and the like.

The water-soluble ether-based solvent is a water-soluble solvent having an ether bond in one molecule. Examples of the water-soluble ether-based solvent include tetrahydrofuran (THF), dioxane, trioxane, 1,2-dimethoxyethane, diethylene glycol dimethyl ether, diethylene glycol diethyl ether, and the like. Among these, the water-soluble ether-based solvent is, for example, preferably tetrahydrofuran, dioxane, and the like.

The water-soluble ketone-based solvent is a water-soluble solvent having a ketone group in one molecule. Examples of the water-soluble ketone-based solvent include acetone, methyl ethyl ketone, cyclohexanone, and the like. Among these, the water-soluble ketone-based solvent is, for example, preferably acetone.

The water-soluble alcohol-based solvent is a water-soluble solvent having an alcoholic hydroxyl group in one molecule. Examples of the water-soluble alcohol-based solvent include methanol, ethanol, 1-propanol, 2-propanol, tert-butyl alcohol, ethylene glycol, ethylene glycol monoalkyl ether, propylene glycol, propylene glycol monoalkyl ether, diethylene glycol, diethylene glycol monoalkyl ether, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerin, 2-ethyl-2-hydroxymethyl-1,3-propanediol, 1,2,6-hexanetriol, and the like. Among these, the water-soluble alcohol-based solvent is, for example, preferably methanol, ethanol, 2-propanol, ethylene glycol, ethylene glycol monoalkyl ether, propylene glycol, propylene glycol monoalkyl ether, diethylene glycol, diethylene glycol monoalkyl ether, and the like.

Examples of the aprotic polar solvent include a solvent having a boiling point of equal to or higher than 150° C. and equal to or lower than 300° C. and a dipole moment of equal to or more than 3.0 D and equal to or less than 5.0 D. Specific examples of the aprotic polar solvent include N-methyl-2-pyrrolidone (NMP), N,N-dimethylformamide (DMF), N,N-dimethylacetamide (DMAc), dimethyl sulfoxide (DMSO), hexamethylene phosphoramide (HMPA), N-methylcaprolactam, N-acetyl-2-pyrrolidone, 1,3-dimethyl-2-imidazolidinone (DMI), N,N′-dimethylpropyleneurea, tetramethylurea, trimethyl phosphate, triethyl phosphate, and the like.

The aqueous solvent, for example, preferably includes an aprotic polar solvent as a solvent other than water. In the aqueous solvent, for example, a content of the aprotic polar solvent is, for example, preferably equal to or more than 1 part by mass and equal to or less than 50 parts by mass with respect to 100 parts by mass of the total amount of particles (resin particles and inorganic particles contained depending on the necessity) which are not dissolved in the polyimide precursor solution.

In a case where the aqueous solvent contains an aprotic polar solvent as a solvent other than water, for example, a content of the aprotic polar solvent is more preferably equal to or more than 3 parts by mass and equal to or less than 45 parts by mass, and further more preferably equal to or more than 5 parts by mass and equal to or less than 45 parts by mass with respect to 100 parts by mass of the particles.

As the aqueous solvent, for example, the aqueous solvent in a resin particle dispersion used for polymerizing the tetracarboxylic acid dianhydride and the diamine compound in the resin particle dispersion prepared in the manufacturing step of the polyimide precursor solution may be used as it is.

As the aqueous solvent, for example, in a case where the polyimide precursor solution further contains inorganic particles as other particles, the aqueous solvent in the inorganic particle dispersion prepared in the manufacturing step may be used as it is.

Polyimide Precursor

The polyimide precursor is a polymer of a tetracarboxylic acid dianhydride and a diamine compound.

The polyimide precursor may be, for example, a resin (polyimide precursor) having a repeating unit represented by General Formula (I).

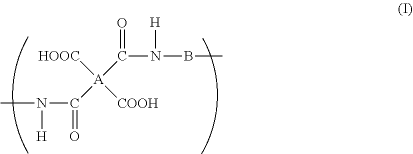

(In General Formula (I), A represents a tetravalent organic group and B represents a divalent organic group.)

Here, in General Formula (I), examples of the tetravalent organic group represented by A include a residue obtained by removing four carboxyl groups from the tetracarboxylic acid dianhydride used as a raw material.

On the other hand, examples of the divalent organic group represented by B include a residue obtained by removing two amino groups from the diamine compound as a raw material.

That is, the polyimide precursor having a repeating unit represented by General Formula (I) is a polymer of a tetracarboxylic acid dianhydride and a diamine compound.

Examples of the tetracarboxylic acid dianhydride include aromatic tetracarboxylic acid dianhydride and aliphatic tetracarboxylic acid dianhydride, and aromatic tetracarboxylic acid dianhydride may be used. That is, in General Formula (I), the tetravalent organic group represented by A may be, for example, an aromatic organic group.

Examples of the tetracarboxylic acid dianhydride include pyromellitic acid dianhydride, 3,3′,4,4′-benzophenone tetracarboxylic acid dianhydride, 3,3′,4,4′-diphenylsulfone tetracarboxylic acid dianhydride, 4,4′-oxydiphthalic acid dianhydride, 3,4′-oxydiphthalic acid dianhydride, 3,3′,4,4′-biphenyl tetracarboxylic acid dianhydride, 2,3,3′,4′-biphenyl tetracarboxylic acid dianhydride, 4,4′-(hexafluoroisopropylidene)diphthalic anhydride, 2,2-bis(3,4-dicarboxyphenyl)propane dianhydride, bis(3,4-dicarboxyphenyl)methane dianhydride, 1,4-bis(3,4-dicarboxyphenoxy)benzene dianhydride, 1,4-bis(2,3-dicarboxyphenoxy)benzene dianhydride, p-phenylene bis(trimellitate anhydride), m-phenylene bis(trimellitate anhydride), 2,2-bis[4-(3,4-dicarboxyphenoxy)phenyl]propane dianhydride, naphthalene-1,4,5,8-tetracarboxylic acid dianhydride, naphthalene-2,3,6,7-tetracarboxylic acid dianhydride, 9,9-bis(3,4-dicarboxyphenyl)fluorene dianhydride, 4,4′-diphenylether bis(trimellitate anhydride), 4,4′-diphenylmethane bis(trimellitate anhydride), 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylether dianhydride, 2,2-bis(4-hydroxyphenyl)propane bis(trimellitate anhydride), p-terphenyl tetracarboxylic acid dianhydride, m-terphenyl tetracarboxylic acid dianhydride, and the like.

Examples of the aliphatic tetracarboxylic acid dianhydride include aliphatic or alicyclic tetracarboxylic acid dianhydride such as butane tetracarboxylic acid dianhydride, 1,2,3,4-cyclobutane tetracarboxylic acid dianhydride, 1,3-dimethyl-1,2,3,4-cyclobutane tetracarboxylic acid dianhydride, 1,2,3,4-cyclopentane tetracarboxylic acid dianhydride, 2,3,5-tricarboxy cyclopentylacetic dianhydride, 3,5,6-tricarboxy norbonane-2-acetate dianhydride, 2,3,4,5-tetrahydrofuran tetracarboxylic acid dianhydride, 5-(2,5-dioxotetrahydrofuryl)-3-methyl-3-cyclohexene-1,2-dicarboxylic acid dianhydride, bicyclo[2,2,2]-oct-7-ene-2,3,5,6-tetracarboxylic acid dianhydride; aliphatic tetracarboxylic acid dianhydride having an aromatic ring such as 1,3,3a,4,5,9b-hexahydro-5-(tetrahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, 1,3,3a,4,5,9b-hexahydro-8-methyl-5-(tetrahydro-2,5-dioxo-3-furanyl)-naphtho[1,2-c]furan-1,3-dione; and the like.

Among these, the tetracarboxylic acid dianhydride may be, for example, aromatic tetracarboxylic acid dianhydride, and specific examples thereof may include pyromellitic acid dianhydride, 3,3′,4,4′-benzophenone tetracarboxylic acid dianhydride, 4,4′-oxydiphthalic anhydride, 3,3′,4,4′-biphenyl tetracarboxylic acid dianhydride, and 2,3,3′,4′-biphenyl tetracarboxylic acid dianhydride, may further include pyromellitic acid dianhydride, 3,3′,4,4′-biphenyl tetracarboxylic acid dianhydride, 3,3′,4,4′-benzophenone tetracarboxylic acid dianhydride, and may particularly include 3,3′,4,4′-biphenyl tetracarboxylic acid dianhydride.

The tetracarboxylic acid dianhydride may be used alone or in combination of two or more thereof.

In addition, in a case where two or more kinds are used in combination, even if the aromatic tetracarboxylic acid dianhydride or the aliphatic tetracarboxylic acid dianhydride are used in combination, the aromatic tetracarboxylic acid dianhydride and the aliphatic tetracarboxylic acid dianhydride may be used in combination.

On the other hand, the diamine compound is a diamine compound having two amino groups in the molecular structure. Examples of the diamine compound include an aromatic diamine compound and an aliphatic diamine compound, and the diamine compound may be an aromatic diamine compound. That is, in General Formula (I), the divalent organic group represented by B may be, for example, an aromatic organic group.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenylether, 4,4′-diaminodiphenylsulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenylether, 2,7-diaminofluorene, 2,2-bis(4-aminophenyl)hexafluoropropane, 4,4′-methyl ene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamines having two amino groups bonded to an aromatic ring such as diaminotetraphenylthiophene and a hetero atom other than nitrogen atom of the amino group; aliphatic diamine and alicyclic diamine such as 1,1-metaxylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylene dimethylenediamine, tricyclo[6,2,1,0^{2.7}]-undecylene dimethyldiamine, and 4,4′-methylene bis(cyclohexylamine); and the like.

Among these, the diamine compound may be aromatic diamine compound, and specific examples thereof may include p-phenylenediamine, m-phenylenediamine, 4,4′-diaminodiphenylmethane, 4,4′-diaminodiphenylether, 3,4′-diaminodiphenylether, 4,4′-diaminodiphenylsulfide, 4,4′-diaminodiphenylsulfone, and may particularly include 4,4′-diaminodiphenylether and p-phenylenediamine.

The diamine compound may be used alone or in combination of two or more kinds thereof. In addition, in a case where two or more kinds are used in combination, an aromatic diamine compound or an aliphatic diamine compound may be used in combination, or an aromatic diamine compound and an aliphatic diamine compound may be used in combination.

In addition, in order to adjust handleability and mechanical properties of the obtained polyimide, for example, there is also a case where two or more kinds of tetracarboxylic acid dianhydride and/or diamine compounds are preferably used for copolymerization.

Examples of the combination of copolymerization include a copolymerization of a tetracarboxylic acid dianhydride and/or diamine compound having one aromatic ring in the chemical structure and a tetracarboxylic acid dianhydride and/or diamine compound having two or more aromatic rings in the chemical structure, a copolymerization of an aromatic tetracarboxylic dianhydride and/or di amine compound and a carboxylic acid dianhydride and/or diamine compound having a flexible linking group such as alkylene group, alkyleneoxy group, and siloxane group, and the like.

A number average molecular weight of the polyimide precursor may be, for example, preferably equal to or more than 5,000 and equal to or less than 300,000, and more preferably equal to or more than 10,000 and equal to or less than 150,000.

In a case where the number average molecular weight of the polyimide precursor is within the range, a decrease in the solubility of the polyimide precursor in a solvent is suppressed, and film-forming properties are easily ensured.

A number average molecular weight of the polyimide precursor is measured by a gel permeation chromatography (GPC) method under the following measurement conditions.
Column: Tosoh TSK gel α-M (7.8 mm I.D×30 cm)
Eluent: dimethylformamide (DMF)/30 mMLiBr/60 mM phosphoric acid
Flow velocity: 0.6 mL/min
Injection amount: 60 μL
Detector: RI (differential refractive index detector)

A content (that is, concentration) of the polyimide precursor may be, for example, preferably equal to or more than 0.1% by mass and equal to or less than 40% by mass, more preferably equal to or more than 0.5% by mass and equal to or less than 25% by mass, and further more preferably equal to or more than 1% by mass and equal to or less than 20% by mass with respect to the entire polyimide precursor solution.

Resin Particles

The resin particles are not particularly limited, but are resin particles made of a resin other than polyimide. Examples thereof include resin particles obtained by polycondensing polymerizable monomers such as polyester resin and urethane resin, and resin particles obtained by radical polymerization of polymerizable monomers such as vinyl resin, olefin resin, and fluororesin. Examples of the resin particles obtained by radical polymerization include resin particles such as (meth)acrylic resin, (meth)acrylic acid ester resin, styrene/(meth)acrylic resin, polystyrene resin, polyethylene resin, and the like.

Among these, the resin particles are, for example, preferably at least one selected from the group consisting of (meth)acrylic resin, (meth)acrylic acid ester resin, styrene/(meth)acrylic resin, and polystyrene resin.

In addition, in the present exemplary embodiment, “(meth)acrylic” means that both “acrylic” and “methacryl” are included.

In addition, the resin particles may or may not be crosslinked. In an imidization step of the polyimide precursor, the resin particles are, for example, preferably non-crosslinked resin particles, from a viewpoint of effectively contributing to the relaxation of residual stress. In addition, the polyimide precursor solution, for example, more preferably contains vinyl resin particles obtained by emulsion polymerization as resin particles, from a viewpoint of simplifying a step of manufacturing the polyimide precursor solution.

In a case where the resin particles are vinyl resin particles, the resin particles are obtained by polymerizing a monomer. Examples of the vinyl resin monomer include monomers shown below. Examples thereof include vinyl resin units obtained by polymerizing a monomer such as styrenes having a styrene skeleton such as styrene, an alkyl-substituted styrene (for example, α-methyl styrene, 2-methyl styrene, 3-methyl styrene, 4-methyl styrene, 2-ethyl styrene, 3-ethylstyrene, 4-ethylstyrene, and the like), a halogen-substituted styrene (for example, 2-chlorostyrene, 3-chlorostyrene, 4-chlorostyrene, and the like), and vinylnaphthalene; esters having a vinyl group such as methyl(meth)acrylate, ethyl(meth)acrylate, n-propyl(meth)acrylate, n-butyl(meth)acrylate, lauryl(meth)acrylate, 2-ethylhexyl(meth)acrylate, and trimethylolpropane trimethacrylate (TMPTMA); vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, vinyl isopropenyl ketone; acids such as (meth)acrylic acid, maleic acid, cinnamic acid, fumaric acid, and vinylsulfonic acid; bases such as ethyleneimine, vinylpyridine, and vinylamine; and the like.

As other monomers thereof, monofunctional monomers such as vinyl acetate, difunctional monomers such as ethylene glycol dimethacrylate, nonane diacrylate, and decanediol diacrylate, and polyfunctional monomers such as trimethylolpropane triacrylate and trimethylolpropane trimethacrylate may be used in combination.

In addition, a vinyl resin may be a resin that is obtained by using one monomer thereof alone, or may be a resin that is a copolymer obtained by using two or more monomers.

The resin particles, for example, preferably have an acidic group on a surface, from a viewpoint of improving dispersion properties and suppressing generation of pinholes. The acidic group present on the surface of the resin particles is considered to function as a dispersant for the resin particles by forming a base and a salt of organic amine compounds and the like used for dissolving the polyimide precursor in an aqueous solvent. Therefore, it is considered that dispersion properties of the resin particles in the polyimide precursor solution are improved.

The acidic group on the surface of the resin particles is not particularly limited, but may be at least one selected from the group consisting of a carboxy group, a sulfonic acid group, and a phenolic hydroxyl group. Among these, the acidic group is, for example, preferably a carboxy group.

The monomer for having an acidic group on the surface of the resin particles is not particularly limited as long as it is a monomer having an acidic group. Examples thereof include a monomer having a carboxy group, a monomer having a sulfonic acid group, a monomer having a phenolic hydroxyl group, and salts thereof.

Specific examples include a monomer having a sulfonic acid group such as p-styrene sulfonic acid and 4-vinylbenzene sulfonic acid; a monomer having a phenolic hydroxyl group such as 4-vinyldihydrosilicate, 4-vinylphenol, and 4-hydroxy-3-methoxy-1-propenylbenzene; a monomer having a carboxy group such as acrylic acid, crotonic acid, methacrylic acid, 3-methylcrotonic acid, fumaric acid, maleic acid, 2-methylisocrotonic acid, 2,4-hexadienedioic acid, 2-pentenoic acid, sorbic acid, citraconic acid, 2-hexenoic acid, monoethyl fumarate; and salts thereof. These monomers having an acidic group may be polymerized by being mixed with a monomer not having an acidic group, or monomers not having an acidic group may be polymerized and granulated, and then monomers having an acidic group on the surface may be polymerized. In addition, these monomers may be used alone or in combination of two or more.

Among these, the monomers are, for example, preferably monomers having a carboxy group such as acrylic acid, crotonic acid, methacrylic acid, 3-methylcrotonic acid, fumaric acid, maleic acid, 2-methylisocrotonic acid, 2,4-hexadienedioic acid, 2-pentenoic acid, sorbic acid, citraconic acid, 2-hexenoic acid, monoethyl fumarate and the like, and salts thereof. The monomer having a carboxy group may be used alone or in combination of two or more.

That is, the resin particles having an acidic group on the surface have, for example, preferably a skeleton derived from a monomer having at least one carboxy group selected from the group consisting of acrylic acid, crotonic acid, methacrylic acid, 3-methylcrotonic acid, fumaric acid, maleic acid, 2-methylisocrotonic acid, 2,4-hexadienedioic acid, 2-pentenoic acid, sorbic acid, citraconic acid, 2-hexenoic acid, monoethyl fumarate, and the like, and salts thereof.

In a case where a monomer having an acidic group and a monomer not having an acidic group are mixed and polymerized, an amount of the monomer having an acidic group is not particularly limited, but in a case where the amount of the monomer having an acidic group is too small, there is a case where dispersion properties of the resin particles in the polyimide precursor solution decrease, and in a case where the amount of the monomer having an acidic group is too large, there is a case where an aggregate of the polymer occurs at a time of emulsion polymerization. Therefore, the monomer having an acidic group is, for example, preferably equal to or more than 0.3% by mass and equal to or less than 20% by mass, more preferably equal to or more than 0.5% by mass and equal to or less than 15% by mass, and particularly preferably equal to or more than 0.7% by mass and equal to or less than 10% by mass, of the entire monomer.

On the other hand, in a case where a monomer not having an acidic group is emulsion-polymerized and then a monomer having an acidic group is further added and polymerized, from the same viewpoint, the amount of the monomer having an acidic group is, for example, preferably equal to or more than 0.01% by mass and equal to or less than 10% by mass, more preferably equal to or more than 0.05% by mass and equal to or less than 7% by mass, and particularly preferably equal to or more than 0.07% by mass and equal to or less than 5% by mass, of the entire monomer.

As described above, the resin particles are, for example, preferably not crosslinked, but in a case where a crosslinking agent is used as at least a part of the monomer component in a case where the resin particles are crosslinked, a proportion of the crosslinking agent in all the monomer components is, for example, preferably equal to or more than 0% by mass and equal to or less than 20% by mass, for example, more preferably equal to or more than 0% by mass and equal to or less than 5% by mass, and for example, particularly preferably 0% by mass.

In a case where the monomer used in the resin constituting the vinyl resin particles contains styrene, a proportion of styrene in all the monomer components is, for example, preferably equal to or more than 20% by mass and equal to or less than 100% by mass, and more preferably equal to or more than 40% by mass and equal to or less than 100% by mass.

The resin particles may be obtained by polymerizing a monomer additionally having an acidic group on the surface of a commercially available product. Specifically, examples of the crosslinked resin particles include crosslinked polymethyl methacrylate (MBX-series, manufactured by Sekisui Kasei Co., Ltd.), crosslinked polystyrene (SBX-series, manufactured by Sekisui Kasei Co., Ltd.), copolymer crosslinked resin particles of methyl methacrylate and styrene (MSX-series, manufactured by Sekisui Kasei Co., Ltd.), and the like.

In addition, examples of the non-crosslinked resin particles include polymethyl methacrylate (MB-series, manufactured by Sekisui Kasei Co., Ltd.), (meth)acrylate ester/styrene copolymer (FS-series: manufactured by Nippon Paint Co., Ltd.), and the like.

A volume average particle diameter of the resin particles is, for example, preferably equal to or more than 0.1 μm and equal to or less than 1 μm, and more preferably equal to or more than 0.25 μm and equal to or less than 0.98 μm, and further more preferably equal to or more than 0.25 μm and equal to or less than 0.95 μm.

The volume particle size distribution index (GSDv) of the resin particles is, for example, preferably equal to or less than 1.30, more preferably equal to or less than 1.25, and further more preferably equal to or less than 1.20.

For the volume average particle diameter and the volume particle size distribution of the resin particles, the volume particle size distribution is obtained by measurement with a laser diffraction type particle size distribution measuring device (for example, Coulter Counter LS13, manufactured by Beckman Coulter, Inc.). Using the obtained particle size distribution, a cumulative distribution is derived from a small particle diameter side for the volume with respect to the divided particle size range (channel), and a particle diameter distribution curve is obtained. The particle diameter distribution curve is drawn by counting the number of particles in increments of 50 nm. In addition, a particle diameter that is cumulatively 50% with respect to all particles is measured as a volume average particle diameter D50v.

In addition, the volume particle size distribution index of the resin particles is calculated as (D84v/D16v)^{1/2} from the particle size distribution of the particles in the polyimide precursor solution. In the volume cumulative distribution drawn from the small diameter side of the volume of the particles, the particle diameter that is 16% cumulative is defined as the volume particle diameter D16v, and the particle diameter that is 50% cumulative is defined as the volume average particle diameter D50v.

A volume content ratio (particles/polyimide precursor) of the resin particles to the polyimide precursor is, for example, preferably equal to or more than 40/60 and equal to or less than 80/20, more preferably equal to or more than 45/55 and equal to or less than 78/22, and further more preferably equal to or more than 50/50 and equal to or less than 74/26.

The content of the resin particles is, for example, preferably equal to or more than 30% by mass and equal to or less than 85% by mass with respect to a total amount of the polyimide precursor and the particles, more preferably equal to or more than 35% by mass and equal to or less than 80% by mass with respect to the total amount of the polyimide precursor and the particles, and further more preferably equal to or more than 40% by mass and equal to or less than 80% by mass.

Imidazole Compound

The polyimide precursor solution of the present exemplary embodiment contains an imidazole compound.

The imidazole compound refers to an amine compound having an imidazole skeleton.

As the imidazole compound, for example, a compound represented by the following Formula (0) is preferable. However, in the following Formula (0), R¹¹, R¹², R¹³, and R¹⁴ each independently represent a hydrogen atom or an alkyl group.

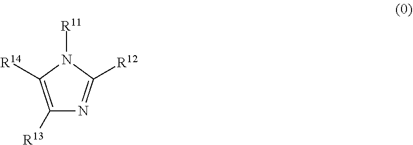

In the imidazole compound represented by the Formula (0), alkyl groups represented by R¹¹, R¹², R¹³, and R¹⁴ may be linear or branched alkyl groups having equal to or more than 1 and equal to or less than 5 carbon atoms (specifically, for example, methyl group, ethyl group, propyl group, butyl group, pentyl group, and the like).

The imidazole compound is, for example, preferably an imidazole compound substituted with two or more alkyl groups. That is, in Formula (0), for example, the imidazole compound is preferably an imidazole compound in which two or more of R¹¹, R¹², R¹³, and R¹⁴ represent an alkyl group.

Specific examples of the imidazole compound include 1,2-dimethylimidazole, 2-ethyl-4-methylimidazole, 4-ethyl-2-methylimidazole, 1-methyl-4-ethylimidazole, 4-methylimidazole, and the like.

The imidazole compound may be used alone or in combination of two or more kinds thereof.

Tertiary Amine Compound Other than Imidazole Compound

The tertiary amine compound in the present exemplary embodiment refers to a tertiary amine compound other than the imidazole compound.

Examples of the tertiary amine compound include acyclic amine compounds and cyclic amine compounds.

Examples of the acyclic amine compound include trialkylamine (tertiary amine compound having an alkyl group), tertiary amino alcohol (tertiary amine compound having an alkyl chain and a hydroxy group), and the like.

Examples of the cyclic amine compound include N-substituted piperazine (amine compound having a piperazine skeleton), N-substituted morpholine (amine compound having a morpholine skeleton), isoquinolines (amine compound having an isoquinoline skeleton), pyridines (amine compound having a pyridine skeleton), pyrimidines (amine compound having a pyrimidine skeleton), pyrazines (amine compound having a pyrazine skeleton), triazines (amine compound having a triazine skeleton), polypyridine, and the like.

The number of carbon atoms of the acyclic amine compound is not particularly limited, but is, for example, preferably equal to or more than 3 and equal to or less than 18, for example, more preferably equal to or more than 3 and equal to or less than 15, and for example, further more preferably equal to or more than 3 and equal to or less than 12.

The number of carbon atoms of the cyclic amine compound is not particularly limited, but is, for example, preferably equal to or more than 3 and equal to or less than 10, for example, more preferably equal to or more than 3 and equal to or less than 9, and for example, further more preferably equal to or more than 3 and equal to or less than 8.

The tertiary amine compound is, for example, preferably at least one compound selected from the group consisting of N-substituted morpholine, trialkylamine, and a tertiary amino alcohol, from a viewpoint of obtaining a porous polyimide film excellent in both filtration properties and air permeability.

As the substituent of the N-substituted morpholine, for example, an alkyl group is preferable.

The number of carbon atoms of the alkyl group is, for example, preferably equal to or more than 1 and equal to or less than 6, more preferably equal to or more than 1 and equal to or less than 5, and further more preferably equal to or more than 1 and equal to or less than 4.

Specific examples of the N-substituted morpholine include N-methylmorpholine, N-ethylmorpholine, N-propylmorpholine, N-butylmorpholine, and the like.

The number of carbon atoms of the alkyl group contained in the trialkylamine is, for example, preferably equal to or more than 1 and equal to or less than 6 more preferably equal to or more than 1 and equal to or less than 5, and further more preferably equal to or more than 1 and equal to or less than 4.

Specific examples of the trialkylamine include triethylamine, trimethylamine, N,N-dimethyl ethyl amine, N,N-dimethyl propyl amine, N,N-dimethylbutyl amine, N,N-diethylmethylamine, N,N-dipropylethylamine and N,N-dimethylisopropylamine, and the like.

The number of carbon atoms of the alcohol contained in the tertiary amino alcohol is, for example, preferably equal to or more than 1 and equal to or less than 6, more preferably equal to or more than 1 and equal to or less than 5, and further more preferably equal to or more than 1 and equal to or less than 4.

In a case where the tertiary amino alcohol has an alkyl group, the number of carbon atoms of the alkyl group is, for example, preferably equal to or more than 1 and equal to or less than 6, more preferably equal to or more than 1 and equal to or less than 5, and further more preferably equal to or more than 1 and equal to or less than 4.

Specific examples of the tertiary amino alcohol include N,N-dimethylethanolamine, N,N-dimethylpropanolamine, N,N-dimethylisopropanolamine, N,N-diethylethanolamine, N-ethyldiethanolamine, N-methyldiethanolamine, triethanolamine, triisopropanolamine, and the like.

From a viewpoint of obtaining a dried film and a polyimide film of a polyimide precursor having high strength, the tertiary amine compound is, for example, further more preferably N-substituted morpholine.

The tertiary amine compound may be used alone or in combination of two or more kinds thereof.

From a viewpoint of obtaining a porous polyimide film excellent in both filtration properties and air permeability, a ratio of the number of moles of the tertiary amine compound to the number of moles of the imidazole compound is equal to or more than 0.3 times in terms of mole and equal to or less than 6.0 times in terms of mole, for example, preferably equal to or more than 0.5 times in terms of mole and equal to or less than 3.0 times in terms of mole, and further more preferably equal to or more than 0.5 times in terms of mole and equal to or less than 2.0 times in terms of mole.

From the viewpoint of obtaining a porous polyimide film excellent in both filtration properties and air permeability, the ratio of the number of moles of the tertiary amine compound to the number of moles of the tetracarboxylic acid dianhydride component of the polyimide precursor is, for example, preferably equal to or more than 0.5 times in terms of mole and equal to or less than 3.0 times in terms of mole, more preferably equal to or more than 0.6 times in terms of mole and equal to or less than 2.5 times of in terms of mole, and further more preferably equal to or more than 0.7 times in terms of mole and equal to or less than 2.0 times in terms of mole.

A total content of the imidazole compound and the tertiary amine compound (a mass of the imidazole compound+a mass of the tertiary amine compound) contained in the polyimide precursor solution according to the present exemplary embodiment is, for example, preferably equal to or more than 1% by mass and equal to or less than 50% by mass, more preferably equal to or more than 2% by mass and equal to or less than 30% by mass, further more preferably equal to or more than 3% by mass and equal to or less than 20% by mass with respect to a total mass of the aqueous solvent contained in the polyimide precursor solution.

The number of moles of the imidazole compound is the number of moles of the imidazole compound contained in the polyimide precursor solution.

In addition, the number of moles of the tertiary amine compound is the number of moles of the tertiary amine compound contained in the polyimide precursor solution.

The number of moles of the tetracarboxylic acid dianhydride component of the polyimide precursor is the number of moles of the tetracarboxylic acid dianhydride in a case of manufacturing the polyimide precursor.

The boiling point of the tertiary amine compound is, for example, preferably lower than the boiling point of the imidazole compound.

In a case where the boiling point of the tertiary amine compound is lower than the boiling point of the imidazole compound, the tertiary amine compound can easily volatilize first during film formation, with this, a concentration gradient can easily occur between the surface of the coating film and the inside of the coating film, and resin particles having a low affinity with the tertiary amine compound can easily adhere to the polyimide precursor inside the coating film. As a result, it becomes easy to obtain a porous polyimide film excellent in both filtration properties and air permeability.

The difference in boiling point between the imidazole compound and the tertiary amine compound (the boiling point of the imidazole compound and the boiling point of the tertiary amine compound) is, for example, preferably equal to or higher than 30° C. and equal to or lower than 200° C., and more preferably equal to or higher than 30° C. and equal to or lower than 150° C.

The boiling point of the tertiary amine compound is, for example, preferably equal to or lower than 150° C., more preferably equal to or lower than 140° C., and further more preferably equal to or lower than 135° C.

The boiling point of the tertiary amine compound is, for example, preferably equal to or higher than 60° C., more preferably equal to or higher than 70° C., and further more preferably equal to or higher than 80° C.

Other Additives

The polyimide precursor solution according to the present exemplary embodiment may contain an additive other than the polyimide precursor, the aqueous solvent, the imidazole compound, the tertiary amine compound, and resin particles. Examples of other additives include a catalyst for accelerating the imidization reaction, a leveling agent for improving film forming quality, and the like.

As the catalyst for promoting the imidization reaction, a dehydrating agent such as an acid anhydride, an acid catalyst such as a phenol derivative, a sulfonic acid derivative, a benzoic acid derivative, and the like may be used.

Method of Manufacturing Porous Polyimide Film

A method of manufacturing a porous polyimide film according to the present exemplary embodiment includes a step (P-1) of applying the polyimide precursor solution according to the present exemplary embodiment onto a substrate to form a coating film, a step (P-2) of drying the coating film to form a dried film, a step (P-3) of peeling the dried film from the substrate, and a step (P-4) of firing the dried film and imidizing the polyimide precursor contained in the dried film to form a porous polyimide film.

According to the manufacturing method according to the present exemplary embodiment, a porous polyimide film excellent in both filtration properties and air permeability is obtained.

Specifically, the polyimide contained in the polyimide film is obtained by polymerizing a tetracarboxylic acid dianhydride and a diamine compound to produce a polyimide precursor, obtaining a solution of the polyimide precursor, and performing imidization reaction.

Hereinafter, a method of manufacturing a polyimide film according to the present exemplary embodiment will be specifically described, but is not limited to this example.

Method of Manufacturing Polyimide Precursor Solution

The method of manufacturing a polyimide precursor solution according to the present exemplary embodiment is not particularly limited, and examples thereof include the following manufacturing methods.

Examples of a method of manufacturing a polyimide precursor solution according to the present exemplary embodiment include a method of obtaining a polyimide precursor solution by polymerizing a tetracarboxylic acid dianhydride and a diamine compound in an aqueous solvent containing an imidazole compound, a tertiary amine compound, and water to produce a polyimide precursor.

According to this method, since the aqueous solvent is applied, the productivity is high, and the polyimide precursor solution is manufactured by one stage, and it is favorable in terms of simplification of the step.

As another example, after a polyimide precursor obtained by polymerizing a tetracarboxylic acid dianhydride and a diamine compound in an organic solvent such as an aprotic polar solvent (for example, N-methyl-2-pyrrolidone (NMP)) is generated, and put into water or an aqueous solvent such as alcohol to precipitate a polyimide precursor. Then, a method of obtaining a polyimide precursor solution by dissolving the precipitated polyimide precursor in an aqueous solvent containing an imidazole compound, a tertiary amine compound, and water is exemplified.

Hereinafter, an example of an appropriate method of manufacturing the polyimide film according to the present exemplary embodiment will be described.

The method of manufacturing a polyimide film according to the present exemplary embodiment includes a step (P-1) which is a first step, a step (P-2) which is a second step, a step (P-3) which is a third step, and a step (P-4) which is a fourth step as exemplified below.

Hereinafter, the first step is referred to as a step (P-1), the second step is referred to as a step (P-2), the third step is referred to as a step (P-3), and the fourth step is referred to as a step (P-4).

Step (P-1)

The step (P-1) is a step of applying a polyimide precursor solution onto a substrate to form a coating film.

In the first step, the polyimide precursor solution according to the present exemplary embodiment is prepared.

Next, the polyimide precursor solution is applied onto the substrate to form a coating film.

The substrate on which the coating film containing the polyimide precursor and the particles is formed is not particularly limited. Examples of the substrate include resin substrates such as polystyrene and polyethylene terephthalate; glass substrates; ceramic substrates; metal substrates such as iron and stainless steel (SUS); composite material substrates in which these materials are combined; and the like. In addition, depending on the necessity, the substrate may be, for example, provided with a release layer by performing a release treatment with a silicone-based or fluorine-based release agent.

The method of applying the polyimide precursor solution onto the substrate is not particularly limited. Examples thereof include various methods such as a spray coating method, a rotary coating method, a roll coating method, a bar coating method, a slit die coating method, and an inkjet coating method.

Step (P-2)

The step (P-2) is a step of drying the coating film obtained in the step (P-1) to form a dried film.

Specifically, the coating film obtained by the step (P-1) is, for example, dried by a method such as heat drying, natural drying, and vacuum drying to form a dried film. More specifically, the dried film is formed by drying the coating film such that the solvent remaining in the dried film is equal to or less than 50% (for example, preferably equal to or less than 30%) with respect to a solid content of the dried film.

Step (P-3)

The step (P-3) is a step of peeling the dried film obtained in the step (P-2) from the substrate.

The method of peeling the dried film is not particularly limited, and examples thereof include a method of winding the dried film with a winder having a drive shaft such as a torque motor, which is installed on a lower side or an upper side of the dried film, and peeling the dried film from the substrate.

In the above description, a case where the dried film is wound into a roll shape is described, but the present disclosure is not limited to this. Instead of winding the dried film into a roll shape, for example, the dried film may be cut at predetermined lengths after peeling.

Step (P-4)

The step (P-4) is a step of firing the dried film peeled from the substrate in the step (P-3) and imidizing the polyimide precursor contained in the dried film to form a polyimide film.

A heating method for obtaining a polyimide film by firing the dried film peeled from the substrate in step (P-3) to proceed imidization is not particularly limited. Examples thereof include a method of performing heating in multiple stages of equal to or more than two stages. For example, the following heating conditions may be exemplified below.

As a heating condition of the first stage, for example, the temperature may be in a range of equal to or higher than 50° C. and equal to or lower than 150° C., and is preferably in a range of equal to or higher than 60° C. and equal to or lower than 140° C. In addition, the heating time may be, for example, in a range of equal to or more than 10 minutes and equal to or less than 60 minutes. The higher the heating temperature, the shorter the heating time may be.

Examples of the heating conditions of the second stage and thereafter include heating under a condition of equal to or higher than 150° C. and equal to or lower than 450° C. (for example, preferably, equal to or higher than 200° C. and equal to or less than 400° C.) for equal to or more than 20 minutes and equal to or lower than 120 minutes. By setting the heating conditions in this range, the imidization reaction further proceeds and a polyimide film can be formed. During the heating reaction, heating may be, for example, performed by increasing the temperature in stages or gradually at a constant rate before the final temperature of heating is reached.

The heating conditions are not limited to the two-stage or higher heating method, and for example, a one-stage heating method may be adopted. In a case of the one-stage heating method, for example, the imidization may be completed only in the heating conditions of second stage or thereafter.

Hereinabove, the method of manufacturing the polyimide film according to the present exemplary embodiment is described, the method of manufacturing a polyimide film according to the present exemplary embodiment is not limited thereto.

For example, in a state where the particles are contained in the polyimide precursor solution, the particles may be removed during the step (P-4) or after the step (P-4) to obtain a porous polyimide film.

### Examples

Hereinafter, the present invention will be described in more detail based on Examples, but the present invention is not limited to the following Examples. The materials, the use amount, the proportion, the treatment procedures, and the like shown in the following examples may be appropriately changed without departing from the spirit of the present disclosure. Unless otherwise specified, “parts” means “parts by mass”.

Preparation of Resin Particle Dispersion

670 parts by mass of styrene, 12.1 parts by mass of surfactant Dowfax2A1 (47% solution, manufactured by Dow Chemical Co., Ltd.), and 670 parts by mass of ion-exchanged water are mixed, agitated at 1,500 rpm for 30 minutes with a dissolver, and emulsified to produce a monomer emulsion.

1.10 parts by mass of Dowfax2A1 (47% solution, manufactured by Dow Chemical Co., Ltd.), and 1,500 parts by mass of ion-exchanged water are put into a reaction vessel. After heating to 75° C. under a nitrogen stream, 70 parts by mass of a monomer emulsion are added, and then a polymerization initiator solution in which 15 parts by mass of ammonium persulfate are dissolved in 98 parts by mass of ion-exchanged water is added dropwise over 10 minutes. After the reaction is carried out for 50 minutes after the dropping, the remaining monomer emulsion is added dropwise over 220 minutes, and the reaction is further carried out for 50 minutes and then cooled to obtain a resin particle dispersion. An average particle diameter of the resin particles is 0.81 μm.

### Examples 1 to 18, Comparative Examples 1 and 2

Production of Polyimide Precursor Solution 1

780 parts of ion-exchanged water are heated to 50° C. under a nitrogen stream, and while agitating, 18.81 parts of p-phenylenediamine (hereinafter, also referred to as “PDA”), and 51.19 parts of 3,3′,4,4′-biphenyltetracarboxylic acid dianhydride (hereinafter, also referred to as “BPDA”) are added. Subsequently, the imidazole compound, the tertiary amine compound, and the ion-exchanged water are added in the type, the amount, and the number of moles shown in Table 1, respectively, under a nitrogen stream at 50° C. for over 120 minutes while agitating. In addition, in the addition of the ion-exchanged water, the ion-exchanged water is added so that the content of the water is the amount shown in Table 1 with respect to the entire aqueous solvent. Then, this mixture is reacted at 50° C. for 15 hours to obtain polyimide precursor solutions 1 to 18 and c1 to c2.

The polyimide precursor solution of each example had a resin particle content of 60% by mass. In addition, a weight average molecular weight of the polyimide precursor contained in the polyimide precursor solution is 40,000.

The following properties of the obtained polyimide precursor solution are shown in Table 1.

Production of Porous Polyimide Film

The polyimide precursor solution obtained in each example is applied onto a glass substrate having a thickness of 1.0 mm in an area of 10 cm×10 cm using an applicator, and dried in an oven at 80° C. for 30 minutes to obtain a film. A gap of the applicator is adjusted so that an average value of the film thickness of the film after drying is 30 μm. The glass substrate on which the film is formed is allowed to stand in an oven heated to 400° C. for 2 hours to fire the film, then immersed in ion-exchanged water, peeled off from the glass substrate, and dried to obtain a porous polyimide film.

For the porous polyimide film of each example, each value of a cross-sectional average micro pore diameter, a first surface micro pore diameter, a second surface micro pore diameter, a ratio (cross-sectional average micro pore diameter/first surface micro pore diameter), the ratio (cross-sectional average micro pore diameter/second surface micro pore diameter), a porosity, and air permeability is shown in Table 2. In addition, layer constitutions of the porous polyimide film of each example are shown in Table 2. Each property is measured by the measurement method described above.

Evaluation of Filtration Properties

The porous polyimide film of each example is cut into a size of 2 cm×2 cm×a thickness of 40 μm to obtain a test specimen. The obtained test specimen is set by being interposed between a funnel of a filter holder for decompression filtration (KGS-04 manufactured by TOYO ROSHI KAISHA, Ltd.) and a base portion. Then, a filtration rate until 20 mL of the liquid containing the particles passes therethrough is measured as a permeation time (min). The obtained permeation time is shown in Table 2 as an evaluation result of filtration properties.

The compound names of the abbreviations described in the columns of the types of imidazole compounds and the types of tertiary amine compounds in Table 1 are as follows.
4MZ: 4-methylimidazole
DMZ: 1,2-dimethylimidazole
2E4MZ: 2-ethyl-4-methylimidazole
MMO: N-methylmorpholine
TEA: Triethylamine
MDEA: N-methyl-diethanolamine
Py: Pyridine
DMAP: 4-dimethylaminopyridine

In Table 2, “-” in the evaluation item indicates that the air permeability is extremely low, and the air permeability cannot be measured and the filtration properties cannot be evaluated.

The “part” of the imidazole compound described in Table 1 is part by mass of the imidazole compound contained in the polyimide precursor solution.

The “number of moles” of the imidazole compound described in Table 1 is the number of moles in a case where mass part of the imidazole compound contained in the polyimide precursor solution is denoted as g.

The “ratio of the number of moles (to acid dianhydride)” of the imidazole compound described in Table 1 is a ratio of the number of moles of the imidazole compound to the number of moles of the tetracarboxylic acid dianhydride component.

The “part” of the tertiary amine compound described in Table 1 is a mass part of the tertiary amine compound contained in the polyimide precursor solution.

The “number of moles” of the tertiary amine compound described in Table 1 is the number of moles in a case where mass part of the tertiary amine compound contained in the polyimide precursor solution is denoted as g.

The “ratio of the number of moles (to acid dianhydride)” of the tertiary amine compound described in Table 1 is the ratio of the number of moles of the tertiary amine compound to the number of moles of the tetracarboxylic acid dianhydride component.

The “ratio of the number of moles” of the tertiary amine compound described in Table 1 is the ratio of the number of moles of the tertiary amine compound to the number of moles of the imidazole compound.

TABLE 1

| | | Immidiszole compound (A) | | | | | Tertiary amine | |
|---|---|---|---|---|---|---|---|---|
| | | | | | Ratio of | | compound (B) | |
| | | | | | number of | | | |
| | Polyimide | | | Number | moles | Boiling | | |
| | precursor | | Amount | of moles | (to acid | point I_{gp} | | Amount |
| | solution | Type | (part) | (mmol) | diaahydride) | (° C.) | Type | (part) |
| Example 1 | 1 | 4MZ | 1.00 | 12.1 | 2.0 | 263 | MMO | 3.10 |
| Example 2 | 2 | 4MZ | 1.51 | 18.4 | 3.0 | 263 | MMO | 2.48 |
| Example 3 | 3 | 4MZ | 2.51 | 30.6 | 5.0 | 263 | MMO | 2.48 |
| Example 4 | 4 | 4MZ | 1.26 | 15.3 | 2.5 | 263 | MMO | 2.57 |
| Comparative | c1 | 4MZ | | 0 | | 263 | MMO | 3.21 |
| Example 1 | | | | | | | | |
| Comparative | c2 | 4MZ | 5.57 | 67.8 | 12 | 263 | MMO | 1.90 |
| Example 2 | | | | | | | | |
| Comparative | c3 | 4MZ | 0.51 | 6.2 | 1 | 263 | MMO | 8.06 |
| Example 3 | | | | | | | | |
| Example 5 | 5 | 4MZ | 1.76 | 21.4 | 3.5 | 263 | MMO | 1.86 |
| Exemple 6 | 6 | 4MZ | 1.26 | 15.3 | 2.5 | 263 | MMO | 2.17 |
| Example 7 | 7 | 4MZ | 2.26 | 27.5 | 4.5 | 263 | MMO | 2.79 |
| Example 8 | 8 | 4MZ | 2.04 | 24.8 | 4.0 | 263 | MMO | 2.42 |
| Example 9 | 9 | 4MZ | 1.00 | 12.2 | 2.0 | 263 | MMO | 8.06 |
| Example 10 | 10 | 4MZ | 1.51 | 18.4 | 3.0 | 263 | MMO | 6.2 |
| Example 11 | 12 | 4MZ | 2.77 | 33.7 | 5.5 | 263 | MMO | 2.79 |
| Example 12 | 12 | 4MZ | 3.27 | 39.8 | 6.5 | 263 | MMO | 3.41 |
| Example 13 | 13 | 4MZ | 3.77 | 45.9 | 7.5 | 263 | MMO | 3.72 |
| Example 14 | 14 | DMZ | 1.26 | 13.3 | 2.5 | 204 | MMO | 4.03 |
| Example 15 | 15 | 2E4MZ | 2.27 | 27.6 | 4.5 | 295 | TEA | 4.34 |
| Example 16 | 16 | 4MZ | 1.76 | 21.4 | 3.5 | 263 | MDEA | 2.79 |
| Example 17 | 17 | 4MZ | 3.27 | 39.8 | 6.5 | 263 | Py | 3.51 |
| Example 18 | 18 | 4MZ | 1.00 | 12.2 | 2.0 | 263 | DMAP | 9 92 |
| | Tertiary amine compound (B) | | | | | | | |
| | | Ratio of | | | | | | |
| | | number of | Ratio of | | | | | |
| | Number | moles | member | | Resin particles | | 1_{BP}- | 1_{BP}- |
| | of moles | (to acid | of moles | Boiling | | Melting | A_{BP} | P_{MP} |
| | (mmol) | dianhydride) | (B)/(A) | point A_{BF} | Type | point P_{MP} | (° C.) | (° C.) |
| Example 1 | 30.6 | 5.0 | 2.53 | 116 | PSt | 240 | 147 | 23 |
| Example 2 | 24.5 | 4.0 | 2.33 | 116 | PSt | 240 | 147 | 23 |
| Example 3 | 24.5 | 4.0 | 0.80 | 116 | PSt | 240 | 147 | 23 |
| Example 4 | 25.4 | 4.5 | 1.66 | 116 | PSt | 240 | 147 | 23 |
| Comparative | 37.7 | 8.0 | 0.00 | 116 | PSt | 240 | 147 | 23 |
| Example 1 | | | | | | | | |
| Comparative | 18.8 | 4.0 | 0.28 | 116 | PSt | 240 | 147 | 23 |
| Example 2 | | | | | | | | |
| Comparative | 79.7 | 13.0 | 12.83 | 116 | PSt | 240 | 147 | 23 |
| Example 3 | | | | | | | | |
| Example 5 | 18.4 | 3.0 | 0.86 | 116 | PSt | 240 | 147 | 23 |
| Exemple 6 | 21.5 | 3.5 | 1.40 | 116 | PSt | 240 | 147 | 23 |
| Example 7 | 27.6 | 4.5 | 1.00 | 116 | PSt | 240 | 147 | 23 |
| Example 8 | 24.5 | 2.0 | 0.99 | 116 | PSt | 240 | 147 | 23 |
| Example 9 | 79.7 | 13 | 6.54 | 116 | PSt | 240 | 147 | 23 |
| Example 10 | 61.3 | 10 | 3.33 | 116 | PSt | 240 | 147 | 23 |
| Example 11 | 27.6 | 4.5 | 0.82 | 116 | PSt | 240 | 147 | 23 |
| Example 12 | 33.7 | 5.5 | 0.85 | 116 | PSt | 240 | 147 | 23 |
| Example 13 | 36.8 | 6.0 | 0.80 | 116 | PSt | 240 | 147 | 23 |
| Example 14 | 39.8 | 6.5 | 2.60 | 116 | PSt | 240 | 88 | 36 |
| Example 15 | 42.9 | 7.0 | 1.55 | 89 | PSt | 240 | 206 | 55 |
| Example 16 | 27.6 | 4.5 | 1.29 | 247 | PSt | 240 | 16 | 36 |
| Example 17 | 34.7 | 5.0 | 0.87 | 115 | PSt | 240 | 148 | 23 |
| Example 18 | 98.1 | 16 | 6.05 | 162 | PSt | 240 | 101 | 23 |

TABLE 2

| | | | | | Ratio (cross- | Ratio (cross- | | | | |
|---|---|---|---|---|---|---|---|---|---|---|
| | | | | | sectional | sectional | | | | |
| | | Cross- | | | average | average | | | | |
| | | sectional | | | micro pore | ancro pore | | | | |
| | | average | | Second | diameter/ | diameter/ | | | | Evaluation |
| | | micro | First surface | surface | first surface | second surface | | | Air | of |
| | Polyimide | pore | micro pore | micro pore | micro pore | micro pore | | Layer | perme- | filtration |
| | precursor | diameter | diameter | diameter | diameter) | dinmeter) | Porosity | constitution | ability | properties |
| | solution | μm | μm | μm | — | — | % | Single layer | second | [min] |
| Example 1 | 1 | 2.5 | 0.42 | 0.85 | 5.95 | 2.94 | 60 | Single layer | 15 | 1.3 |
| Example 2 | 2 | 2.8 | 0.44 | 0.85 | 6.36 | 3.18 | 56 | Single layer | 17 | 1.4 |
| Example 3 | 3 | 2.2 | 0.35 | 0.74 | 6.29 | 2.97 | 54 | Single layer | 19 | 1.6 |
| Example 4 | 4 | 6.2 | 0.83 | 1.98 | 7.47 | 3.13 | 60 | Single layer | 13 | 1.2 |
| Comparative | c1 | 1.8 | 0.43 | 0.87 | 4.19 | 2.07 | 47 | Single layer | 398 | 5.3 |
| Example 1 | | | | | | | | | | |
| Comparative | c2 | 4.8 | 0.42 | 1.93 | 11.4 | 2.49 | 40 | Single layer | — | — |
| Example 2 | | | | | | | | | | |
| Comparative | c3 | 6.3 | 0.43 | 2.8 | 14.7 | 2.25 | 40 | Single layer | 360 | 4.8 |
| Example 3 | | | | | | | | | | |
| Example 5 | 5 | 10.8 | 2.1 | 3.89 | 5.14 | 2.78 | 58 | Single layer | 38 | 2.1 |
| Example 6 | 6 | 0.38 | 0.043 | 0.24 | 8.84 | 1.58 | 38 | Single layer | 278 | 3.2 |
| Example 7 | 7 | 20.3 | 3.6 | 8.60 | 5.64 | 2.36 | 62 | Single layer | 42 | 2.3 |
| Example 8 | 8 | 0.22 | 0.04 | 0.18 | 5.50 | 1.22 | 39 | Single layer | 292 | 2.7 |
| Example 9 | 9 | 3.5 | 0.43 | 1.23 | 8.02 | 2.80 | 64 | Single layer | 10 | 1.1 |
| Example 10 | 10 | 1.5 | 0.27 | 0.67 | 5.63 | 2.27 | 42 | Single layer | 95 | 3.0 |
| Example 11 | 11 | 4.2 | 0.61 | 0.62 | 6.89 | 6.77 | 45 | Single layer | 98 | 2.9 |
| Example 12 | 12 | 2.1 | 0.42 | 1.2 | 5.00 | 1.75 | 48 | Single layer | 36 | 2.1 |
| Example 13 | 13 | 19.7 | 3.8 | 20.1 | 5.18 | 0.98 | 56 | Single layer | 34 | 2.2 |
| Example 14 | 14 | 0.3 | 0.054 | 0.094 | 5.93 | 3.40 | 41 | Single layer | 256 | 1.9 |
| Example 15 | 15 | 3.20 | 0.42 | 0.85 | 7.62 | 3.76 | 43 | Single layer | 126 | 2.5 |
| Example 16 | 16 | 3.30 | 0.44 | 0.76 | 7.30 | 4.34 | 44 | Single layer | 97 | 2.7 |
| Example 17 | 17 | 4.20 | 0.48 | 0.71 | 8.75 | 5.92 | 41 | Single layer | 105 | 3.2 |
| Example 18 | 18 | 3.60 | 0.42 | 0.88 | 8.87 | 4.09 | 41 | Single layer | 120 | 3.3 |

From the results shown in the tables, it is found that the porous polyimide film produced by using the polyimide precursor solution of Example is more excellent in both filtration properties and air permeability as compared with the porous polyimide film produced by using the polyimide precursor solution of Comparative Example.
(((1)))

A porous polyimide film,

wherein a ratio of a cross-sectional average micro pore diameter (μm) to a first surface micro pore diameter (μm) on one surface (the cross-sectional average micro pore diameter/the first surface micro pore diameter) is equal to or more than 5 and equal to or less than 10.
(((2)))

The porous polyimide film according to (((1))),

wherein the first surface micro pore diameter is equal to or more than 50 nm and equal to or less than 2 μm.
(((3)))

The porous polyimide film according to (((2))),

wherein the first surface micro pore diameter is equal to or more than 50 nm and equal to or less than 1.8 μm.
(((4)))

The porous polyimide film according to any one of (((1))) to (((3))),

wherein the cross-sectional average micro pore diameter is equal to or more than 250 nm and equal to or less than 20 μm.
(((5)))

The porous polyimide film according to (((4))),

wherein the cross-sectional average micro pore diameter is equal to or more than 250 nm and equal to or less than 18 μm.
(((6)))

The porous polyimide film according to any one of (((1))) to (((5))),

wherein an air permeability is equal to or less than 20 seconds.
(((7)))

The porous polyimide film according to any one of (((1))) to (((6))), wherein a porosity is equal to or more than 40%.
(((8)))

The porous polyimide film according to any one of (((1))) to (((7))),

wherein a ratio of the cross-sectional average micro pore diameter (μm) to the second surface micro pore diameter (μm) on an opposite side of the one surface (the cross-sectional average micro pore diameter/a second surface micro pore diameter) is equal to or more than 2 and equal to or less than 5.
(((9)))

The porous polyimide film according to (((8))),

wherein the second surface micro pore diameter is equal to or more than 100 nm and equal to or less than 15 μm.
(((10)))

The porous polyimide film according to any one of (((1))) to (((9))),

wherein the porous polyimide film has a single layer.
(((11)))

A polyimide precursor solution comprising:
an aqueous solvent containing water;
a polyimide precursor that is a polymer of a tetracarboxylic acid dianhydride and a diamine compound;
resin particles;
an imidazole compound; and
a tertiary amine compound other than the imidazole compound,
wherein a ratio of the number of moles of the imidazole compound to the number of moles of a tetracarboxylic acid dianhydride component of the polyimide precursor is equal to or more than two times in terms of mole and equal to or less than 10 times in terms of mole, and
a ratio of the number of moles of the tertiary amine compound to the number of moles of the tetracarboxylic acid dianhydride component of the polyimide precursor is equal to or more than two times in terms of mole and equal to or less than 18 times in terms of mole.
(((12)))

The polyimide precursor solution according to (((11))),

wherein a difference between a boiling point of the imidazole compound and a boiling point of the tertiary amine compound other than the imidazole compound is equal to or higher than 30° C. and equal to or lower than 200° C.
(((13)))

The polyimide precursor solution according to (((11))) or (((12))),

wherein a difference between a boiling point of the imidazole compound and a melting point of the resin particles is equal to or higher than 20° C. and equal to or lower than 50° C.
(((14)))

The polyimide precursor solution according to any one of (((11))) to (((13))),

wherein a water content is equal to or more than 50% by mass with respect to the aqueous solvent.
(((15)))

The polyimide precursor solution according to any one of (((11))) to (((14))),

wherein the ratio of the number of moles of the imidazole compound to the number of moles of the tetracarboxylic acid dianhydride component of the polyimide precursor is equal to or more than two times in terms of mole and equal to or less than 6 times in terms of mole.
(((16)))

The polyimide precursor solution according to (((15))),

wherein the ratio of the number of moles of the tertiary amine compound to the number of moles of the tetracarboxylic acid dianhydride component of the polyimide precursor is equal to or more than two times in terms of mole and equal to or less than 15 times in terms of mole.
(((17)))

A method of manufacturing a porous polyimide film, comprising:
applying the polyimide precursor solution according to (((11))) onto a substrate to form a coating film;
drying the coating film to form a dried film;
peeling the dried film from the substrate; and
firing the dried film and imidizing the polyimide precursor contained in the dried film to form a porous polyimide film.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A porous polyimide film,
wherein a ratio of a cross-sectional average micro pore diameter (μm) to a first surface micro pore diameter (μm) on one surface (the cross-sectional average micro pore diameter/the first surface micro pore diameter) is equal to or more than 5 and equal to or less than 10.

2. The porous polyimide film according to claim 1,
wherein the first surface micro pore diameter is equal to or more than 50 nm and equal to or less than 2 μm.

3. The porous polyimide film according to claim 2,
wherein the first surface micro pore diameter is equal to or more than 50 nm and equal to or less than 1.8 μm.

4. The porous polyimide film according to claim 1,
wherein the cross-sectional average micro pore diameter is equal to or more than 250 nm and equal to or less than 20 μm.

5. The porous polyimide film according to claim 2,
wherein the cross-sectional average micro pore diameter is equal to or more than 250 nm and equal to or less than 20 μm.

6. The porous polyimide film according to claim 4,
wherein the cross-sectional average micro pore diameter is equal to or more than 250 nm and equal to or less than 18 μm.

7. The porous polyimide film according to claim 5,
wherein the cross-sectional average micro pore diameter is equal to or more than 250 nm and equal to or less than 18 μm.

8. The porous polyimide film according to claim 1,
wherein an air permeability is equal to or less than 20 seconds.

9. The porous polyimide film according to claim 2,
wherein an air permeability is equal to or less than 20 seconds.

10. The porous polyimide film according to claim 1,
wherein a porosity is equal to or more than 40%.

11. The porous polyimide film according to claim 1,
wherein a ratio of the cross-sectional average micro pore diameter (μm) to the second surface micro pore diameter (μm) on an opposite side of the one surface (the cross-sectional average micro pore diameter/a second surface micro pore diameter) is equal to or more than 2 and equal to or less than 5.

12. The porous polyimide film according to claim 11,
wherein the second surface micro pore diameter is equal to or more than 100 nm and equal to or less than 15 μm.

13. The porous polyimide film according to claim 1,
wherein the porous polyimide film has a single layer.

14. A polyimide precursor solution comprising:
an aqueous solvent containing water;
a polyimide precursor that is a polymer of a tetracarboxylic acid dianhydride and a diamine compound;
resin particles;
an imidazole compound; and
a tertiary amine compound other than the imidazole compound,
wherein a ratio of the number of moles of the imidazole compound to the number of moles of a tetracarboxylic acid dianhydride component of the polyimide precursor is equal to or more than two times in terms of mole and equal to or less than 10 times in terms of mole, and
a ratio of the number of moles of the tertiary amine compound to the number of moles of the tetracarboxylic acid dianhydride component of the polyimide precursor is equal to or more than two times in terms of mole and equal to or less than 18 times in terms of mole.

15. The polyimide precursor solution according to claim 14,
wherein a difference between a boiling point of the imidazole compound and a boiling point of the tertiary amine compound other than the imidazole compound is equal to or higher than 30° C. and equal to or lower than 200° C.

16. The polyimide precursor solution according to claim 14,
wherein a difference between a boiling point of the imidazole compound and a melting point of the resin particles is equal to or higher than 20° C. and equal to or lower than 50° C.

17. The polyimide precursor solution according to claim 14,
wherein a content of the water is equal to or more than 50% by mass with respect to the aqueous solvent.

18. The polyimide precursor solution according to claim 14,
wherein the ratio of the number of moles of the imidazole compound to the number of moles of the tetracarboxylic acid dianhydride component of the polyimide precursor is equal to or more than two times in terms of mole and equal to or less than 6 times in terms of mole.

19. The polyimide precursor solution according to claim 18,
wherein the ratio of the number of moles of the tertiary amine compound to the number of moles of the tetracarboxylic acid dianhydride component of the polyimide precursor is equal to or more than two times in terms of mole and equal to or less than 15 times in terms of mole.

20. A method of manufacturing a porous polyimide film, comprising:
applying the polyimide precursor solution according to claim 11 onto a substrate to form a coating film;
drying the coating film to form a dried film;
peeling the dried film from the substrate; and
firing the dried film and imidizing the polyimide precursor contained in the dried film to form a porous polyimide film.
